(19) United States
(12) Patent Application Publication
(10) Pub. No.: US 2005/0066351 A1
(43) Pub. Date: Mar. 24, 2005

(54) Audio broadcasting signal disruption sensor and backup program source

(76) Inventor: Robert J. Robson, Kelowna (CA)

Correspondence Address: ANTONY C. EDWARDS, SUITE 800 - 1708 DOLPHIN AVENUE, KELOWNA, BC, V1Y 9S4, CA

(21) Appl. No.: 10/937,346

(22) Filed: Sep. 10, 2004

Related U.S. Application Data
(60) Provisional application No. 60/501,416, filed on Sep. 10, 2003.

(51) Int. Cl. H04N 7/16

(52) U.S. Cl. 725/13

(57) ABSTRACT

An audio broadcasting signal disruption sensor and backup program source for providing an alternate audio programming sources in the event of primary-source audio programming failure so as to automatically switch to a backup alternate audio programming source feeding an output audio stream for broadcasting. The system includes monitoring an audio stream from a primary-sources audio programming output, detecting a substantially constant amplitude waveform in the audio stream, determining that the substantially constant amplitude waveform remains of substantially constant amplitude continuously for a threshold period of time, switching the output audio stream from the primary-source audio programming to the alternate audio programming source upon expiry of the threshold period of time, and providing notice of any main-source audio programming failure to administrative personnel.

### CROSS REFERENCE TO RELATED APPLICATION

This application claims priority from U.S. Provisional Patent Application No. 60/501,416 filed Sep. 10, 2003 entitled Audio Broadcasting Signal Disruption Sensor.

### FIELD OF THE INVENTION

This invention relates to a device for automatically monitoring a digital or analog audio signal, detecting a change in that audio signal, automatically inputting pre-recorded substitute audio, alerting both local and remote personnel to the audio signal interruption and permitting such personnel to remotely monitor and rectify the condition.

### BACKGROUND OF THE INVENTION

The transmission of an audio signal by, for example, a radio station is normally a continuously fluctuating stream of sound with the exception of relatively short scheduled silent interruptions between program items. The occasional unscheduled, non-fluctuating audio interruptions occurring from equipment failure or operator error may not be immediately detected by an operator and may last an extended period of time resulting in inconvenience and annoyance to listeners and both embarrassment and potential loss of advertising revenue to the operator. Such audio signals are also subject to degradation by various forms of constant amplitude noise, which is not as readily discernable as a complete loss of audio, but nevertheless has the same disquieting results.

It is an object of this invention to provide a device, which will automatically detect various forms of constant amplitude sound, for example a change from a fluctuating to an non-fluctuating audio stream or alternatively, an unwanted constant background signal such as static in a digital or analog audio signal and which will automatically activate a substitute pre-recorded audio signal.

A further object of this invention is to provide an audio broadcast signal disruption sensor, which will automatically alert key personnel at a local or remote location when such disruption is detected.

A further object is to permit emergency services or other authorized personnel to remotely replace the normal audio broadcast stream with special announcements, for example public safety information.

A further object of this invention is to permit personnel who have been notified of a disruption to remotely access and monitor the audio signal generating system and perform a number of specified functions to correct the detected problem.

A further object is to provide a self contained, simple to operate device for monitoring an audio broadcast signal, which can be installed and operated by non-technical personnel.

A further object is to provide an automatic means to record portions of an audio broadcast signal for later playback as a replacement for disrupted program audio or for reference purposes.

### SUMMARY OF THE INVENTION

In summary, the present invention combines the functions of a silence or other non-fluctuating signal sensor, an alternate audio source, and a remote control system in a single device. It is an electronic audio monitoring device, which is designed for installation within an audio signal transmitting path or footprint of, for example, a radio station or similar enterprise, where the quality of transmitted sound is important. This device may be located either at the studio of such a station or near a transmitter facility so as to constantly monitor the quality of the sound passing through the monitoring device.

The assumption relied on herein, and which is generally true, is that a radio station audio stream is a random waveform, which changes from moment to moment. In the monitoring device of the present invention the digital or analog input signal is converted to direct current, which also fluctuates in concert with the input signal and which is then periodically sampled by a micro-controller to detect an absence of change in the direct current flow. Such absence of change will then indicate that the fluctuating audio signal has been replaced by a non-fluctuating signal such as silence or a constant amplitude signal such as static. Upon the detection of a constant amplitude signal, a predetermined countdown sequence is activated, after which the micro-controller substitutes pre-recorded audio into the audio signal transmitting path. It also activates an audible alarm and an integral telephone line or network connection alerts key personnel at a local or remote location when such disruption is detected. The use of an open microphone connected through the micro-controller temporarily disables operation of the audible alarm.

Audio playback equipment built into the device is capable of playing audio recordings from optical media (such as CD's, CD-R, CD-R/W, DVD-R, DVD-R/W) or magnetic media (such as hard drive) or removable solid-state memory. The recordings may be encoded using an audio compression protocol, for example MP-3, MP-2, or WMA. The audio output from the playback may be monitored through an internal speaker or by means of headphones without affecting the main audio stream. Connecting the headphones to the device automatically disables the internal speaker. Pausing or stopping the built in audio playback equipment permits the incoming audio signal to pass either to the speaker or to the headphones thus enabling the pre-recorded audio and the normal outgoing audio stream to be properly balanced by using easily accessible front panel controls.

An isolation amplifier presents high impedance to an incoming audio stream, thus avoiding degradation to the analog signal being looped through the system. A fader amplifier permits a smooth transition from the main to the backup audio stream.

Personnel at a remote location who are contacted through the integral telephone or network connection can access the micro-controller and receive audio prompts for one or more fault tracing menus, which guide the operator through interactive fault tracing procedures for the controller and other equipment attached to it.

In summary, the present invention may be characterized as a method and apparatus having an audio broadcasting signal disruption sensor and backup program source for providing an alternate audio programming source in the event of primary-source audio programming failure so as to automatically switch to a backup alternate audio programming source feeding an output audio stream for broadcasting. The method and apparatus include, respectively:
a) monitoring, and processor means for monitoring an audio stream from a primary-source audio programming output,
b) detecting, and processor means for detecting a substantially constant amplitude waveform in the audio stream,
c) determining by a processor, and processor means for determining that the substantially constant amplitude waveform remains of substantially constant amplitude continuously for a threshold period of time,
d) switching, and switching, means for switching the output audio stream from the primary-source audio programming to the alternate audio programming source upon expiry of the threshold period of time, and
e) providing notice by notification alarm means (collectively alarm means) for providing notice of the main-source audio programming failure to administrative personnel.

The alarm means may include means for notification of the administrative personnel by at least one of either telephone or digital network. The alarm means may be interactive and adapted for receiving feedback from said personnel to at least over-ride said switching means. The present invention also provides for automatically re-switching, and means for automatically re-switching, the source of the output audio stream back to the main-source audio programming upon detection by the detecting means of a return to a random waveform in the incoming audio stream from the main-source audio programming. Advantageously, the primary-source audio programming and the alternate source of audio programming are both of the same recording format. The present invention may also include an input signal converter, wherein the audio stream from the primary-source audio programming is converted by the input signal converter to a direct current the flow of which fluctuates with fluctuations in the waveform of the audio stream, and wherein the detecting means detects lack of change in the flow of the direct current. In a preferred embodiment, the switching means includes a countdown timer counting down from a pre-set threshold period of time which may be within substantially the range of two seconds to ten minutes. The alarm means may include means of notification of said administrative personnel by at least one of either telephone or digital network. The detecting means may advantageously periodically sample the audio stream from said primary-source audio programming. The alarm means may be interactive and adapted for receiving feedback from the personnel to at least over-ride the switching means.

### BRIEF DESCRIPTION OF THE DRAWINGS

FIG. 1, is a schematic electrical diagram of one embodiment of the monitoring device according to the present invention.

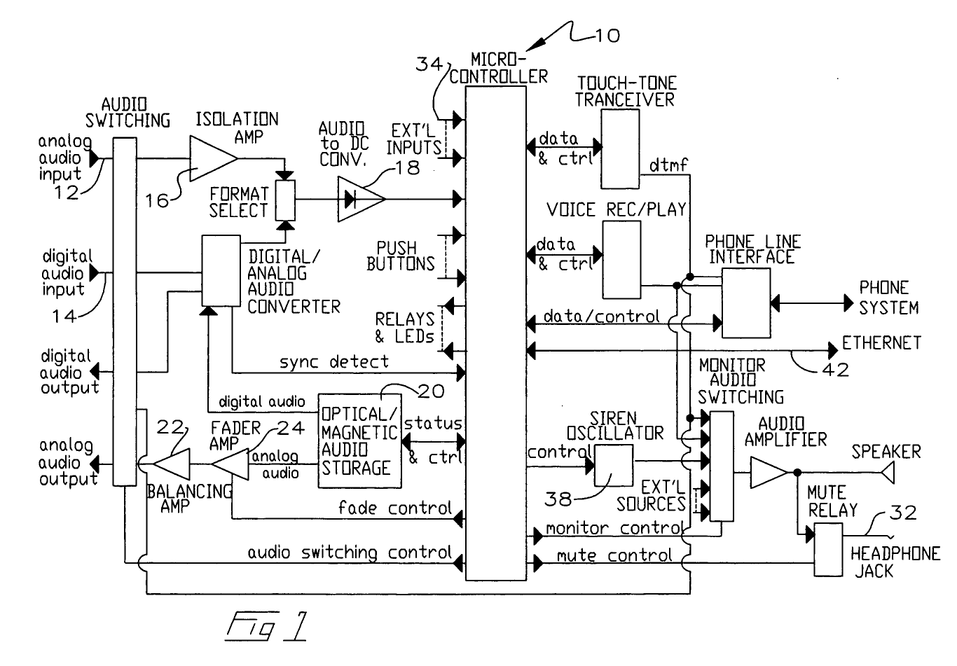

FIG. 2 is a front elevation view of one embodiment of the device of FIG. 1.

FIG. 3 is an isometric view of the device of FIG. 2.

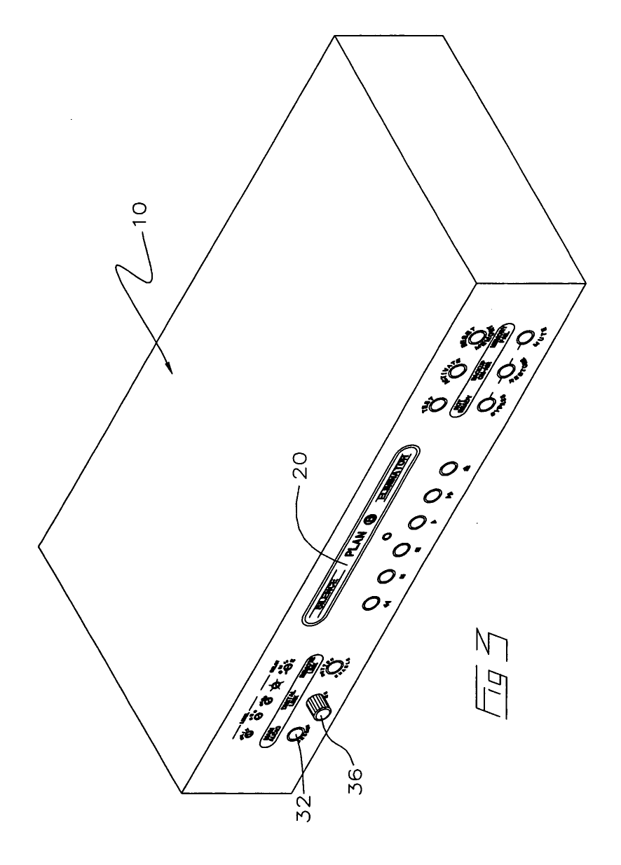

FIG. 4 is rear elevation view of the device of FIG. 2.

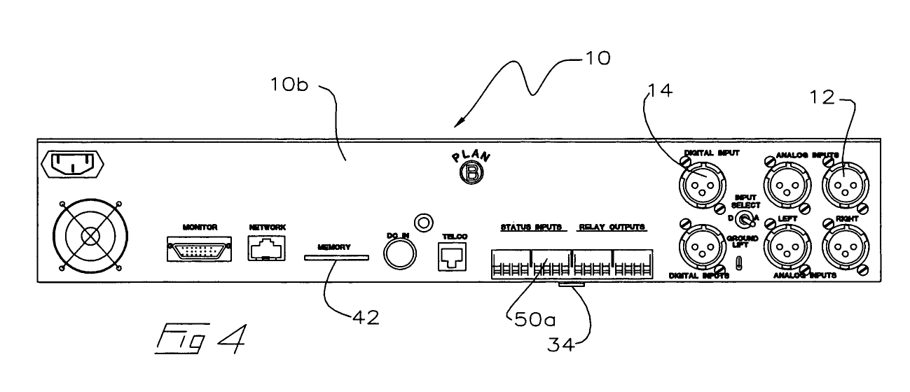

### DETAILED DESCRIPTION OF EMBODIMENTS OF THE INVENTION

With reference to the drawing figures, wherein similar characters of reference denote corresponding parts in each view, an electronic audio monitoring micro-controller 10 accepts either an analog or digital audio signal at inputs 12 and 14 respectively. The audio signal is the signal being broadcast, for example from a radio station. It is thus presumed that in conventional operation the audio signal is a random waveform.

The analog audio signal passes through a high impedance isolation amplifier 16 to avoid degradation of the signal. Both the analog and digital audio signals are converted to direct current (DC) by a converter 18 which feeds the electrical signal into an analog input port on micro-controller 10 where it is periodically sampled to detect an absence of change in the DC voltage.

Back-up audio is pre-recorded so as to be selectively playable for example from an optical/magnetic storage device 20. Audio from storage device 20 may be matched to the volume of the incoming audio stream through balancing amp 22. Fader amplifier 24 allows for a smooth transition of back-up audio into or out from the main audio stream.

Microcontroller 10 initiates or activates a countdown sequence when an incoming audio failure is detected by microcontroller 10 detecting an absence of fluctuation in the DC signal from converter 18. DELAY selector 30, on front panel 10a, controls the duration of the countdown sequence, which is continuously variable for example from two seconds to ten minutes. At the end of the countdown the headphone jack 32 is muted, the volume control 36 is bypassed, and siren 38 is activated. FAIL signal light 40 flashes on the front panel and an auxiliary relay activates external equipment. The integral autodialer continuously dials up several numbers in sequence until the contacted personnel acknowledge the alarm situation. Notification emails may also be transmitted to personnel via an Ethernet connection 42.

The party remotely contacted by telephone is prompted by a pre-recorded message for a touch-tone password. Acknowledgement of the password permits the contacted party to: monitor the incoming (main) audio; monitor the backup (disc) audio; force the backup on-line or off-line; bypass the system (prevent changeover); activate three independent auxiliary relays; monitor status on three external DC inputs; set which status input(s) will activate the autodialer (if any); program the telephone number sequences into the autodialer; and, set the password and the incoming ring delay. These functions are also available via the Ethernet connection.

When a valid incoming audio stream returns after a failure, the unit reconnects the audio stream to the output jack(s), fades down the replacement audio, stops the disc drive and disconnects it from the output jack(s). The FAIL MEMORY indicator 40 on the front panel flashes once for each activation of the backup system since the RESET MEMORY button 48 was pushed. A log of backup activations is maintained in memory and may be accessed via the Ethernet connection.

The present device may be forced either on or off or bypassed by means of buttons located front panel 110a. Pairs of buttons are used simultaneously to set the RANDOM or RESUME modes for disc player 20. The audible alarm may be muted by a separate front panel pushbutton 50 or it can be temporarily muted by an external closure to a pair of contacts 34 on a pluggable terminal block 50a on the rear panel 10b of controller 10. All panel pushbuttons are protected from accidental activation by a BUTTON ENABLE switch 54 positioned at the left side of front panel 10a away from other pushbuttons.

The device of the present invention may be housed in a 5.25 inches (13.3 cm) high 2U aluminium chassis intended for installation in a standard 19″ EIA (Electronic Industries Alliance™) equipment rack. The unit is approximately 12 inches (30.5 cm) deep and weighs approximately 10.0 lbs. (4.5 kg).

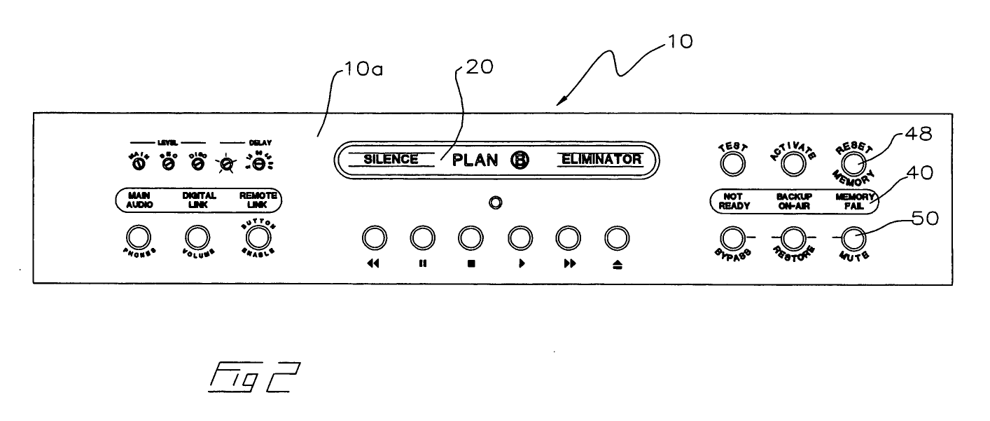

The front panel contains a central motorized disc loading drawer, thirteen pushbutton switches, nine indicator lights, a headphone jack, a volume control, and five screwdriver-adjust controls (see FIG. 2).

The rear panel contains six XLR-type connectors for AES3 digital audio and stereo balanced analog audio connections to external equipment. Also located on the rear panel are an input audio format select switch (digital or analog), an audio ground-lift switch, a modular telephone jack, a chassis ground terminal, a removable terminal block for DC connections to external equipment, the power cable connector, a video monitor accessory jack, a modular Ethernet jack, and a solid-state memory card slot.

A side-firing internal loudspeaker is mounted on the left-hand side of the chassis behind a metal grille.

Operation

The device of the present invention is designed primarily for installation in the audio path of a radio station's “air chain”: the serial connection of critical, on-air equipment. It may be located either at the studio or at a transmitter facility. Because the unit will be activated by the failure of any system that precedes it in the air chain, the device of the present invention will typically be located adjacent to the main audio processor or the studio-to-transmitter link (STL). The unit utilizes gold-contact passive switching and high-impedance isolation amplifiers to render the effects of its insertion into the signal path insignificant.

The user determines whether a digital (AES3) or analog signal is to be protected by selecting the appropriate position on a rear-panel toggle switch, and making the appropriate connections via the rear-panel XLR-type connectors. The presence of input audio is indicated by the appearance of the words “MAIN AUDIO” in green lettering on the front panel. Additionally, the words “DIGITAL LINK” will appear in green if there is a valid digital audio connection.

Input audio sensitivity is adjusted with a front-panel trimmer control, and can be monitored via headphones or the built-in loudspeaker, both of which are adjusted via a front-panel volume control knob.

Backup, that is, substitute, audio is prerecorded onto a Compact Disc and loaded into the motorized disc tray, or onto internal magnetic storage media. The disc drive is intended to play most standard CD, CD-R, and CD-R/W discs, as well as those encoded using the MP-3 and MP-2 audio compression protocols. It is therefore possible for the device of the present invention to provide over twenty hours of non-repeating backup audio programming from either storage media.

A green “READY” indication appears on the front panel when a valid disc has been loaded into the drive, and when the unit has not been bypassed either via the front-panel pushbutton or by a remote telephone connection. If the unit has been bypassed, or if the disc drawer is empty or contains an unreadable disc, “NOT READY” appears in flashing yellow letters.

Pre-recorded audio may be played through the unit's built-in speaker or headphone jack without affecting the main audio stream. When backup audio is played manually (by pushing the PLAY button below the disc drawer), the audio is automatically routed to the headphone jack and speaker, and can be adjusted with the front-panel volume control. Putting the player in “PAUSE” or “STOP” will allow the incoming audio to once again appear at the speaker or headphone jack. This makes it possible to easily balance the levels of the main and backup audio sources by ear, using the front-panel trimmer controls.

The device of the present invention has two audio media playback modes. The “RANDOM” mode will play each track on the disc in random order, starting with a different track each time the system is activated. The “RESUME” mode will play each track on the disc in sequence until the alarm condition is over, and will continue playback from the next unplayed track on the disc the next time the system is activated.

The failure-detection algorithm in the micro-controller constantly monitors the degree of change in the incoming audio stream in the manner that would be known and conventional to one skilled in the art. The algorithm is therefore capable of detecting various forms of constant-amplitude noise, as well as silence. When an incoming audio failure condition is detected (either constant amplitude noise or silence), the micro controller begins a countdown sequence before activating an alarm condition. The duration of the countdown is determined by the setting of the front panel DELAY, and is continuously variable for example from two seconds to ten minutes.

The following series of events takes place when an alarm condition is met.
a) The audio media player is activated, and its audio is switched onto the unit's output jack(s).
b) The main audio source is disconnected from the unit's output jack(s).
c) The headphone jack is muted, the monitor volume control is bypassed, and an electronic siren is heard through the speaker.
d) “FAIL” appears in rapidly flashing red letters on the front panel.
e) An auxiliary relay is closed to activate external equipment.
f) The unit's integral autodialer dials up to three user-programmed telephone numbers in sequence. These numbers can be up to 64 digits each to allow for international long distance codes, calling cards, etc. The dialing sequence continues until the alarm condition is acknowledged by contacted personnel.
g) Alarm notification emails are transmitted to recipients on a user-programmed list via the Ethernet connection.

The device of the present invention will also respond to an incoming ring on its Public Switched Telephone Network (PSTN) connection. The remote user is prompted by a pre-recorded voice for a touch-tone password. Once this password is correctly input, the dialogue with the unit (menus, commands, etc.) is the same as if the system had instigated the call in an alarm condition. Similarly, the device will also respond to a request made to its Internet Protocol (IP) address via the Ethernet connection. The remote user is similarly prompted for a password, which must be correctly input before the remote user is allowed to proceed. After the unit reports its status, the user can perform the following functions via a telephone or Ethernet connection to the unit:
a) monitor the incoming (main) audio;
b) monitor the backup (disc) audio;
c) force the backup on-line or off-line;
d) force the telephone audio on-line;
e) bypass the system (prevent changeover);
f) activate three independent auxiliary relays;
g) monitor status on three external DC inputs;
h) set which status input(s) will activate the autodialer (if any);
i) program the telephone number sequences into the autodialer;
j) set the password and the incoming ring delay;
k) review the activation log;
l) configure miscellaneous recording and playback options.

During a remote session, “REMOTE LINK” appears on the front panel in yellow, and the front panel pushbuttons are temporarily disabled. This is to avoid the confusion that could be caused if more than one user was attempting to control the system at the same time.

The device of the present invention can be forced on, forced off, or bypassed with front-panel pushbuttons. Simultaneous pairs of buttons are used to set the RANDOM and RESUME disc playback modes. The audible alarm can be muted by a separate front-panel pushbutton, or it can be temporarily muted with an external closure to a pair of contacts on the rear-panel pluggable terminal block. All front-panel pushbuttons are protected from accidental activation by a BUTTON ENABLE switch at the left side of the front panel, away from the other pushbuttons.

When a valid incoming main audio stream returns after a failure, the unit reconnects the incoming audio to the output jack(s), fades down the backup audio, stops the disc drive, and disconnects it from the output jack(s). A “FAIL MEMORY” indicator on the front panel flashes once for every activation of the backup system since the last push of the “RESET MEMORY” button.

The unit's power supply can be replaced in the field without affecting the digital or analog audio passing through the system. All user settings are retained indefinitely in EEPROM memory, even when the system is powered down. These settings include programmed autodialer numbers, disc playback mode, and external status input alarms.

Thus it may be seen that the system of the present invention provides radio stations and other sources of audio programming with a self-contained alternate program source in the event of main-source failure. The system constantly monitors an incoming digital or analog audio stream to detect silence or noise, and automatically injects, that is, switches to a substitute audio stream of the same format. The system may automatically reinstate the primary audio stream and disconnect the substitute audio stream upon the restoration of the primary audio stream. The system may utilize passive switching to route incoming audio non-invasively. The substitute audio source may include one or more integral optical/magnetic drives which play pre-recorded audio files discs in several formats, including for example CD-DA and MP-3. The system may provide a continuous substitute audio stream by optionally repeating audio file playback. The system may generate an audible alarm and provides a relay closure for interfacing to external equipment. The alarm may be muted by external equipment to maintain silence in open-microphone environments. The system may visually indicate the number of failures to the incoming audio stream since the last time the failure memory was reset. The system may be manually bypassed to allow for intentional interruptions to the incoming audio stream. Through a connection to the Public Switched Telephone Network (PSTN), the system may automatically dial several user-programmed telephone numbers and report system status using a pre-recorded human voice, or may, through a connection to the Internet, automatically send email notification of alarm conditions to several user-programmed email addresses. The system may allow a remote user to establish a connection to the system, for example, the Internet. Through such a connection to the Internet, a remote user may be allowed to review and update stored audio files including recordings of the incoming audio stream. The system allows a user to remotely monitor the source audio stream and the system-generated substitute audio stream via the PSTN. The system allows a remote user to interrupt primary audio programming and provide emergency announcements from the PSTN directly to the audio stream. The system allows a remote user to stop, start, reset, bypass, and otherwise remotely control the system via the Internet, or using a telephone keypad via the PSTN. The system allows a remote user to monitor and control external equipment using a telephone keypad via the PSTN or the Internet. The system provides integral loudspeaker and headphone monitoring of incoming digital or analog audio stream, or backup audio. The system retains all user settings in EEPROM memory indefinitely.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

1. An audio broadcasting signal disruption sensor and backup program source for providing an alternate audio programming source in the event of primary-source audio programming failure so as to automatically switch to a backup alternate audio programming source feeding an output audio stream for broadcasting, comprising:
a) processor means for monitoring an audio stream from a primary-source audio programming output,
b) processor means for detecting a substantially constant amplitude waveform in said audio stream,
c) processor means for determining that said substantially constant amplitude waveform remains of substantially constant amplitude continuously for a threshold period of time,
d) switching means for switching the output audio stream from said primary-source audio programming to the alternate audio programming source upon expiry of said threshold period of time,
e) alarm means for providing notice of the main-source audio programming failure to administrative personnel.

2. The device of claim 1 further comprising means for automatically re-switching the source of said output audio stream back to the main-source audio programming upon detection by said detecting means of a return to a random waveform in the incoming audio stream from the main-source audio programming.

3. The device of claim 2 wherein said primary-source audio programming and said alternate source of audio programming are both of the same recording format.

4. The device of claim 2 further comprising an input signal converter, wherein the audio stream from said primary-source audio programming is converted by said input signal converter to a direct current the flow of which fluctuates with fluctuations in the waveform of the audio stream, and wherein said detecting means detects lack of change in the flow of said direct current.

5. The device of claim 1 wherein said switching means includes a countdown timer counting down from a pre-set said threshold period of time.

6. The device of claim 5 wherein said threshold period of time is within substantially the range of two seconds to ten minutes.

7. The device of claim 1 wherein said alarm means includes means for notification of said administrative personnel by at least one of either telephone or digital network.

8. The device of claim 1 wherein said detecting means periodically samples the audio stream from said primary-source audio programming.

9. The device of claim 1 wherein said alarm means is interactive and adapted for receiving feedback from said personnel to at least over-ride said switching means.

10. For use with audio broadcasting signal disruption sensor and backup program source for providing an alternate audio programming source in the event of primary-source audio programming failure so as to automatically switch to a backup alternate audio programming source feeding an output audio stream for broadcasting, a method of detecting disruption of an audio signal for broadcast and for substituting a backup program source comprising the steps of:
a) monitoring by a processor means an audio stream from a primary-source audio programming output,
b) detecting by said processor means a substantially constant amplitude waveform in said audio stream,
c) determining by said processor means that said substantially constant amplitude waveform remains of substantially constant amplitude continuously for a threshold period of time,
d) switching by switching means the output audio stream from said primary-source audio programming to the alternate audio programming source upon expiry of said threshold period of time,
e) providing notice by alarm means of the main-source audio programming failure to administrative personnel.

11. The method of claim 10 further comprising the step of automatically re-switching the source of said output audio stream back to the main-source audio programming upon detection by said detecting means of a return to a random waveform in the incoming audio stream from the main-source audio programming.

12. The method of claim 10 further comprising the step of providing said primary-source audio programming and said alternate source of audio programming in both the same recording format.

13. The method of claim 11 further comprising the step of converting, by an input signal converter, the audio stream from said primary-source audio programming to a direct current the flow of which fluctuates with fluctuations in the waveform of the audio stream, and detecting by said detecting means lack of change in the flow of said direct current.

14. The method of claim 10 wherein said switching step includes counting down in from a preset said threshold period of time.

15. The method of claim 14 further comprising the step of pre-setting said threshold period of time is within substantially the range of two seconds to ten minutes.

16. The method of claim 10 wherein said step of providing notice includes notification of said administrative personnel by at least one of either telephone or digital network.

17. The method of claim 10 wherein said detecting step includes periodically sampling the audio stream from said primary-source audio programming.

18. The device of claim 10 wherein said step of providing notice is interactive and includes receiving feedback from said personnel so as to at least over-ride said switching step.
